(19) United States
(12) Patent Application Publication
(10) Pub. No.: US 2022/0105640 A1
(43) Pub. Date: Apr. 7, 2022

(54) Method Of Calibrating A Tool Of An Industrial Robot, Control System And Industrial Robot

(71) Applicant: ABB Schweiz AG, Baden (CH)

(72) Inventors: Johan Noren, Västerås (SE); Sven Hanssen, Västerås (SE); Hans Andersson, Västerås (SE); Peter Fixell, Västerås (SE)

(21) Appl. No.: 17/426,888

(22) PCT Filed: Feb. 7, 2019
(86) PCT No.: PCT/EP2019/053020

§ 371 Date: Jul. 29, 2021

(51) Int. Cl. B25J 9/16; B25J 11/00

(52) U.S. Cl. CPC B25J 9/1692; B25J 9/163; B25J 11/005; B25J 9/1664; B25J 9/1653

(57) ABSTRACT

A method of calibrating a tool of an industrial robot, the method including positioning a tool center point of the tool in relation to a reference target in at least one calibration position of the robot; for each calibration position, recording a joint position of at least one joint of the robot; calculating tool data based on the at least one joint position in each calibration position and based on a kinematic model of the robot, the tool data including a definition of the tool center point; determining an error of the calculated tool data; and modifying at least one kinematic parameter of the robot based on the error to reduce the error. A control system for calibrating a tool of an industrial robot and an industrial robot including the control system, are also provided.

### TECHNICAL FIELD

The present disclosure generally relates to calibration of industrial robots. In particular, a method of calibrating a tool of an industrial robot, a control system for calibrating a tool of an industrial robot, and an industrial robot comprising the control system, are provided.

### BACKGROUND

An industrial robot comprising a serial kinematics manipulator may be viewed as a chain of links. Two adjacent links may be joined with each other so that they either are rotatable or translatable relative to each other. The last link in the chain is usually a tool attachment, such as a tool flange, for attachment of various tools. To be able to determine the position of the robot, each joint is usually provided with an angle measuring device in the form of an encoder or a resolver indicating the position of the joint relative to a zero position.

Before a robot can be used it must be calibrated, e.g. calibrating each of the angle measuring devices with reference to the zero position. When a tool is mounted on the last axis, the robot also needs to know the actual position of the active point of the tool, the tool center point (TCP), which for instance can be the muzzle of a spot welding tool. For this reason, a tool center point calibration may be performed when the tool is changed.

One known way to calibrate the tool is by a so-called TCP four-point calibration where a reference target in a workspace of the robot is approached as accurately as possible. This is then repeated by approaching the reference target with several different positions of the robot, e.g. with several different orientations of the tool. The reference target is for instance the tip of a nail.

By moving the robot such that the tool center point approaches the tip of the reference target in at least four different positions of the robot, the coordinates of the tool center point and an error thereof can be calculated by solving a least squares optimization problem. The tool center point coordinates may be expressed in a wrist coordinate system, i.e. in the last link of the robot. The error may for example depend on calibration errors, mechanical errors such as tolerances, and gravity. A large error means that the tool center point definition is inaccurate which results in deteriorated performance of the robot.

WO 2015165062 A1 discloses a method for calibrating a tool center point and mentions an example of a TCP four-point calibration.

### SUMMARY

One object of the present disclosure is to provide a simple, yet accurate, method of calibrating a tool of an industrial robot.

A further object of the present disclosure is to provide a more accurate method of calibrating a tool of an industrial robot, which method involves positioning a tool center point of the tool in relation to a reference target.

A further object of the present disclosure is to provide a method of calibrating a tool of an industrial robot, which method enables more accurate movements of the tool.

A further object of the present disclosure is to provide a method of calibrating a tool of an industrial robot, which method enables more accurate reorientations of the tool.

A still further object of the present disclosure is to provide a cheap method of calibrating a tool of an industrial robot.

A still further object of the present disclosure is to provide a method of calibrating a tool of an industrial robot, which method solves several or all of the foregoing objects in combination.

A still further object of the present disclosure is to provide a control system for calibrating a tool of an industrial robot, which control system solves one, several or all of the foregoing objects.

A still further object of the present disclosure is to provide an industrial robot solving one, several or all of the foregoing objects.

According to one aspect, there is provided a method of calibrating a tool of an industrial robot, the method comprising positioning a tool center point of the tool in relation to a reference target in at least one calibration position of the robot; for each calibration position, recording a joint position of at least one joint of the robot; calculating tool data based on the at least one joint position in each calibration position and based on a kinematic model of the robot, the tool data comprising a definition of the tool center point; determining an error of the calculated tool data; and modifying at least one kinematic parameter of the robot based on the error to reduce the error.

The position of the reference target may be known. In this case, the calculation of the tool data may also be based on the position of the reference target. Alternatively, the position of the reference target may be unknown. In this case, also the reference target can be calculated based on the at least one joint position in each calibration position and based on the kinematic model of the robot.

The positioning of the tool center point in relation to the reference target may be made under manual control, e.g. by jogging the robot into one or more calibration positions. Alternatively, the positioning of the tool center point in relation to the reference target can be made automatically. In each calibration position, the tool center point may or may not be in physical contact with the reference target. The calculation of the tool data may be made using a least squares optimization algorithm.

Once the one or more joint positions have been recorded, the method can be carried out without necessarily requiring any additional measurements that may require additional measuring instruments. The only external equipment (external to the robot) needed for the tool calibration method is the reference target. Thus, the method is simple and cheap.

The method according to the present disclosure may not always generate the most accurate definition of the tool center point. However, a more accurate tool center point generated by, for example, a coordinate measuring machine (CMM) may not be the tool center point that generates the most accurate reorientation of the tool when moving the robot. In some cases, the tool center point can be more accurately determined by using a CMM. However, once the at least one kinematic parameter has been modified according to the method of the present disclosure, the method enables a more accurate reorientation of the tool, despite not necessarily having the most accurate tool data, e.g. as measured by CMM.

A kinematic parameter may be any parameter that affects a definition of the tool center point. Although the present disclosure primarily describes kinematic parameters as joint positions, the method may be carried out by modifying alternative kinematic parameters. For example, the modification of at least one kinematic parameter may comprise moving a base coordinate system of the robot, e.g. as expressed in a world coordinate system.

The at least one kinematic parameter may be constituted by at least one software kinematic parameter. Alternatively, or in addition, the kinematic parameter may be one or more hardware kinematic parameters. Examples of software kinematic parameters are the joint positions and the positioning of the base coordinate system. Examples of hardware kinematic parameters are sensor positions or motor positions of the joints.

The reference target may be fixed in the workspace of the robot. The position of the reference target may be expressed in the world coordinate system. In case the position of the reference target in the world coordinate system is known, the reference target can be expressed in the base coordinate system by using a transformation between the world coordinate system and the base coordinate system. However, the method can also be carried out with an unknown position of the reference target.

The determination of the error of the calculated tool data may comprise determining an error of the calculated tool center point. By modifying the at least one kinematic parameter such that the error of the tool center point is reduced, the method constitutes a method of calibrating the tool center point.

The tool data may further comprise a definition of an orientation of the tool. Thus, the tool data may comprise various geometric data of the tool. In this case, the determination of the error of the calculated tool data may comprise determining an error of the calculated tool center point and/or the calculated orientation of the tool. The tool data may also comprise further data of the tool, for example the weight of the tool, load on the tool, center of gravity of the tool and moments of inertia.

The method may further comprise controlling the robot to execute a movement using the at least one modified kinematic parameter.

The positioning of the tool center point in relation to the reference target may be made in a plurality of different calibration positions of the robot, such as in four different calibration positions. In each calibration position, the tool may be oriented differently with respect to the reference target. As a possible alternative, the tool may be oriented in the same way with respect to the reference target in several or all different calibration positions of the robot.

The method may further comprise modifying the kinematic model based on the at least one modified kinematic parameter. The kinematic parameter is in this case a software kinematic parameter. A kinematic parameter according to the present disclosure may alternatively be a physical parameter of the robot, i.e. a hardware kinematic parameter. For example, a sensor or a motor of a joint may be modified.

The at least one kinematic parameter may comprise at least one joint position. In this case, the modification of the at least one joint position to reduce the error of the calculated tool data constitutes a calibration of the at least one joint position. By calibrating the at least one joint position, also the tool is calibrated. According to one variant, only or primarily a fourth joint and a fifth joint of the robot are modified to reduce the error. A modification of a joint position does not mean that the physical joint is moved, but rather that a definition of a physical position of the joint is changed. Alternatively, or in addition, the at least one kinematic parameter may comprise a positioning of the base coordinate system of the robot, e.g. a transformation from the world coordinate system to the base coordinate system.

The modification of the at least one kinematic parameter may comprise an optimization of the at least one kinematic parameter to reduce the error. For example, the modification of the at least one kinematic parameter may comprise an optimization of the at least one joint position to reduce the error. This type of modification may be said to constitute a post-optimization of joint calibration to calibrate the tool.

The modification of the at least one kinematic parameter may comprise performing optimization of joint position modifications of the at least one recorded joint position to satisfy an objective function of minimizing the error of the tool center point, and to output at least one optimized joint position; and using the at least one optimized joint position as the modified at least one kinematic parameter.

The optimization may or may not be constrained. For example, constraints reflecting end positions of one or more joints may be imposed.

The reference target may be a single point. Alternatively, the reference target may be an object having a definable geometric shape, such as a sphere, cylinder or cube. In any case, the position of the reference target may be either known or unknown to the robot.

The method may comprise positioning the tool center point in relation to a single reference target in at least one calibration position. That is, the method may be carried out by using only one reference target.

The error may be determined as the average distance in at least one direction of the calculated tool center point to the reference target in the at least one calibration position. Alternatively, the error may be determined as the maximum distance in at least one direction of the calculated tool center point to the reference target among the at least one calibration position. The average distance or the maximum distance may be expressed in only one direction, for example along an X-axis of a wrist coordinate system, or in several directions (X, Y, Z).

According to a further aspect, there is provided a control system for calibrating a tool of an industrial robot, the control system comprising a data processing device and a memory having a computer program stored thereon, the computer program comprising program code which, when executed by the data processing device, causes the data processing device to perform the steps of: for each of at least one calibration position of the robot, where a tool center point of the tool is positioned in relation to a reference target, recording a joint position of at least one joint of the robot; calculating tool data based on the at least one joint position in each calibration position and based on a kinematic model of the robot, the tool data comprising a definition of the tool center point; determining an error of the calculated tool data; and modifying at least one kinematic parameter of the robot based on the error to reduce the error. The computer program may further comprise program code which, when executed by the data processing device, causes the data processing device to perform any step and/or command execution of any step according to the present disclosure.

According to a further aspect, there is provided an industrial robot comprising a control system according to the present disclosure. Throughout the present disclosure, the industrial robot may comprise at least one serial kinematics manipulator programmable in three or more axes, such as a six or seven axis manipulator. The robot may thus comprise at least three joints, i.e. one joint for each axis. Each joint may be either a rotational joint or a translational joint. A joint position may thus be a rotational position or a translational position.

### BRIEF DESCRIPTION OF THE DRAWINGS

Further details, advantages and aspects of the present disclosure will become apparent from the following embodiments taken in conjunction with the drawings, wherein:

FIG. 1: schematically represents a side view of an industrial robot comprising a tool;

FIG. 2: schematically represents the tool in relation to a reference target in different calibration positions of the robot; and

FIG. 3: schematically represents the tool in relation to an alternative reference target in different calibration positions of the robot.

### DETAILED DESCRIPTION

In the following, a method of calibrating a tool of an industrial robot, a control system for calibrating a tool of an industrial robot, and an industrial robot comprising the control system, will be described. The same reference numerals will be used to denote the same or similar structural features.

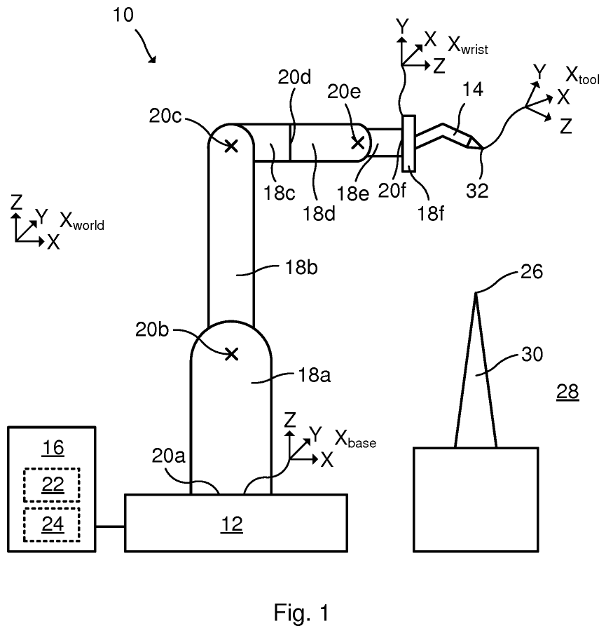

FIG. 1 schematically represents a side view of an industrial robot 10. The robot 10 is exemplified as a six-axis industrial robot comprising a serial kinematics manipulator programmable in six axes but the present disclosure is not limited to this particular type of robot.

The robot 10 of this example comprises a base 12, a tool 14, and a control system 16, such as a robot controller. The robot 10 further comprises a first link member 18a rotatable around a vertical axis relative to the base 12 at a first joint 20a, a second link member 18b rotatable around a horizontal axis relative to the first link member 18a at a second joint 20b, a third link member 18c rotatable around a horizontal axis relative to the second link member 18b at a third joint 20C, a fourth link member 18d rotatable relative to the third link member 18c at a fourth joint god, a fifth link member 18e rotatable relative to the fourth link member 18d at a fifth joint Zoe, and a sixth link member 18f rotationally movable relative to the fifth link member 18e at a sixth joint 20f. The sixth link member 18f comprises a tool flange (not denoted) having an interface to which the tool 14 is attached. Each of the joints 20a-20f is also referred to with reference numeral “20” and each of the link members 18a-18f is also referred to with reference numeral “18”.

The control system 16 comprises a data processing device 22 (e.g. a central processing unit, CPU) and a memory 24. A computer program is stored in the memory 24. The computer program may comprise program code which, when executed by the data processing device 22, causes the data processing device 22 to execute any step, or to command execution of any step, according to the present disclosure.

A robot program, a kinematic model of the robot 10 and a dynamic model of the robot 10 are also implemented in the control system 16. The control system 16 is configured to generate drive signals to motors (not shown) of each joint 20 based on movement instructions from the robot program and the kinematic and dynamic models of the robot 10.

FIG. 1 further shows a reference target 26 fixedly positioned in a workspace 28 of the robot 10. The reference target 26 of this example is constituted by the tip of a nail 30, i.e. a single point. The method for calibrating the tool 14 according to the present disclosure may be carried out with only one reference target 26 in the workspace 28.

The position of the reference target 26 may be either known or unknown. In this example, the position of the reference target 26 is known. The position of the reference target 26 may for example be expressed in a world coordinate system X_{world} and transformed into a base coordinate system X_{base} of the robot 10. The base coordinate system X_{base} is positioned on the base 12 at the intersection between the base 12 and the first link member 18a along the rotational axis of the first joint 20a.

FIG. 1 further denotes a wrist coordinate system X_{wrist}. The wrist coordinate system X_{wrist} is positioned on the last link member 18f at the intersection between the fifth link member 18e and the sixth link member 18f along the rotational axis of the sixth joint 20f.

The tool 14 comprises a tool center point 32. When movements of the robot 10 are programmed by specifying a path for the robot 10 to follow, the robot 10 aims to move such that the tool center point 32 follows this path. Although several tool center points 32 can be defined for each tool 14, only one tool center point 32 is active at a given time.

A tool coordinate system Xₜₒₒₗ is positioned with its origin at the tool center point 32. The tool coordinate system Xₜₒₒₗ is expressed in the wrist coordinate system X_{wrist}. If for example the tool 14 is replacing a previous damaged tool 14, the old robot program can still be used if the tool coordinate system Xₜₒₒₗ is redefined.

As illustrated in FIG. 1, the orientation of the tool coordinate system Xₜₒₒₗ differs from the orientation of the wrist coordinate system X_{wrist}. Thus, in order to define the tool coordinate system Xₜₒₒₗ in this case, tool data containing both the position of the tool center point 32 and the orientation of the tool 14 may be used. If however the tool coordinate system Xₜₒₒₗ has the same orientation as the wrist coordinate system X_{wrist}, the tool data may contain only a definition of the tool center point 32.

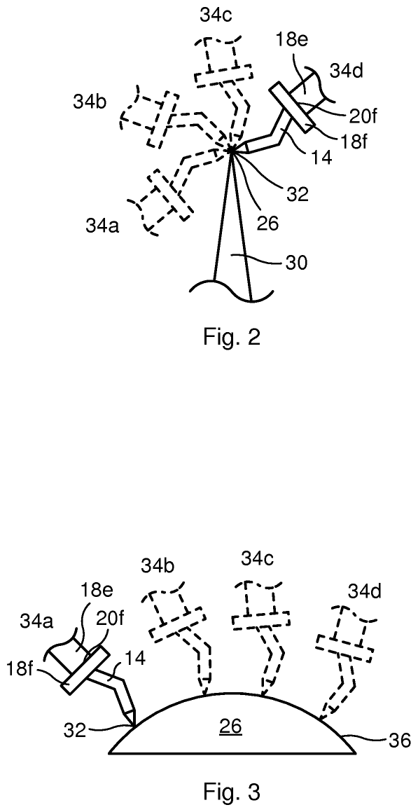

FIG. 2 schematically represents the tool 14 in relation to the reference target 26 in a plurality of different calibration positions 34a, 34b, 34c, 34d of the robot 10. Each of the calibration positions 34a, 34b, 34c, 34d is also collectively referred to with reference numeral “34”

With reference to FIGS. 1 and 2, one specific example of a method of calibrating the tool 14 will now be described. The calibration method may for example be conducted by a service technician as a service routine.

The robot 10 is jogged to position the tool center point 32 as close as possible to the reference target 26 in a first calibration position 34a of the robot 10, for example by operating a teach pendant (not shown). When the robot 10 has been jogged to the calibration position 34a, a set of joint positions, such as the joint positions of each joint 20, are recorded, for example based on a command from the operator via the teach pendant. The joint positions give information on how each joint 20 is positioned when the robot 10 adopts the calibration position 34a.

The above procedure is then repeated for the further calibration positions 34b, 34c, 34d. In this example, the robot 10 is jogged to position the tool center point 32 as close as possible to the reference target 26 in a second, third and fourth calibration position 34b, 34c, 34d. In each calibration position 34b, 34c, 34d, the positions of the joints 20 are recorded. As shown in FIG. 2, the tool center point 32 contacts the reference target 26 in each calibration position 34. This constitutes one example of a positioning of the tool center point 32 in relation to the reference target 26. The robot 10 may alternatively be moved automatically to each calibration position 34. FIG. 2 further illustrates that the tool 14 is oriented in a unique position with respect to the reference target 26 in each calibration position 34.

Based on the joint positions recorded in the calibration positions 34, based on the position of the reference target 26 (which in this example is known), and based on the kinematic model of the robot 10, tool data of the tool 14 can be calculated. An error of the tool data can also be calculated.

In this example, tool data constituted by the tool center point 32, and an error thereof, are calculated. The calculations can be made using a least squares optimization algorithm by insisting that if the correct coordinates of the tool center point 32 are found, then the sum of the squared variations in the calculated location of the reference target 26 is minimal, but allowing for a residual error. The residual error may for example depend on motion inaccuracies, kinematics of the robot 10, calibration of the joints 20, and gravity.

An optimization of joint position modifications is then performed to reduce the error. For example, an optimization problem with an objective function for determining the error is provided. The value of the objective function is then minimized based on joint position modifications as optimization variables to output optimized joint positions. This constitutes one example of modifying kinematic parameters of the robot 10 to reduce the error of the tool center point 32. The method may comprise an optimization of kinematic parameters other than, or in addition to, the joint positions. The modified kinematic parameters, here the optimized joint positions, are then added to the kinematic model of the robot 10 for use by the control system 16 when controlling movements of the robot 10.

The method has been tested by the applicant on both simulated and real robots 10. In both cases, a calibration error was deliberately introduced to one of the joints 20. The method correctly identified and corrected the introduced calibration error.

FIG. 3 schematically represents the tool 14 in relation to an alternative reference target 26 in different calibration positions 34a, 34b, 34c, 34d of the robot 10. Mainly differences with respect to FIG. 2 will be described.

The reference target 26 in FIG. 3 has a spherical surface 36 of known radius and thereby constitutes one example of an object having a definable geometric shape. By knowing or calculating the shape of the reference target 26, the tool center point 32 of the tool 14 can be positioned in arbitrarily calibration positions 34 in relation to the surface 36 of the reference target 26, for example by contacting unique points of the surface 36 in each calibration position 34.

While the present disclosure has been described with reference to exemplary embodiments, it will be appreciated that the present invention is not limited to what has been described above. For example, it will be appreciated that the dimensions of the parts may be varied as needed.

1. A method of calibrating a tool of an industrial robot, the method comprising the steps of:
positioning a tool center point of the tool in relation to a reference target in at least one calibration position of the robot;
for each calibration position, recording a joint position of at least one joint of the robot;
calculating tool data based on the at least one joint position in each calibration position and based on a kinematic model of the robot, the tool data including a definition of the tool center point;
determining an error of the calculated tool data; and
modifying at least one kinematic parameter of the robot based on the error to reduce the error.

2. The method according to claim 1, wherein the determination of the error of the calculated tool data includes determining an error of the calculated tool center point.

3. The method according to claim 1, wherein the tool data further comprises a definition of an orientation of the tool.

4. The method according to claim 1, further comprising controlling the robot to execute a movement using the at least one modified kinematic parameter.

5. The method according to claim 1, wherein the positioning of the tool center point in relation to a reference target is made in a plurality of different calibration positions of the robot.

6. The method according to claim 1, further comprising modifying the kinematic model based on the at least one modified kinematic parameter.

7. The method according to claim 1, wherein the at least one kinematic parameter comprises at least one joint position.

8. The method according to claim 1, wherein the modification of the at least one kinematic parameter includes an optimization of the at least one kinematic parameter to reduce the error.

9. The method according to claim 1, wherein the modification of the at least one kinematic parameter comprises:
performing optimization of joint position modifications of the at least one recorded joint position to satisfy an objective function of minimizing the error of the tool center point, and to output at least one optimized joint position; and
using the at least one optimized joint position as the modified at least one kinematic parameter.

10. The method according to claim 1, wherein the reference target is single point.

11. The method according to claim 1, wherein the reference target has a definable geometric shape.

12. The method according to claim 1, wherein the error is determined as the average distance in at least one direction of the calculated tool center point to the reference target in the at least one calibration position.

13. The method according to claim 1, wherein the error is determined as the maximum distance in at least one direction of the calculated tool center point to the reference target among the at least one calibration position.

14. A control system for calibrating a tool of an industrial robot, the control system comprising a data processing device and a memory having a computer program stored thereon, the computer program comprising program code which, when executed by the data processing device, causes the data processing device to perform the steps of:
for each of at least one calibration position of the robot, where a tool center point of the tool is positioned in relation to a reference target, recording a joint position of at least one joint of the robot;
calculating tool data based on the at least one joint position in each calibration position and based on a kinematic model of the robot, the tool data including a definition of the tool center point;
determining an error of the calculated tool data; and
modifying at least one kinematic parameter of the robot based on the error to reduce the error.

15. An industrial robot comprising a control system having a data processing device and a memory with a computer program stored thereon, the computer program including program code which, when executed by the data processing device, causes the data processing device to perform the steps of:
for each of at least one calibration position of the robot, where a tool center point of the tool is positioned in relation to a reference target, recording a joint position of at least one joint of the robot;
calculating tool data based on the at least one joint position in each calibration position and based on a kinematic model of the robot, the tool data including a definition of the tool center point;
determining an error of the calculated tool data; and
modifying at least one kinematic parameter of the robot based on the error to reduce the error.

16. The method according to claim 2, wherein the tool data further comprises a definition of an orientation of the tool.

17. The method according to claim 2, further comprising controlling the robot to execute a movement using the at least one modified kinematic parameter.

18. The method according to claim 2, wherein the positioning of the tool center point in relation to a reference target is made in a plurality of different calibration positions of the robot.
